(19) United States
(12) Patent Application Publication
(10) Pub. No.: US 2013/0181828 A1
(43) Pub. Date: Jul. 18, 2013

(54) DELIVERING AN ITEM OF INTEREST

(71) Applicants: Rajan Lukose, Oakland, CA (US); Craig Peter Sayers, Menlo Park, CA (US)

(72) Inventors: Rajan Lukose, Oakland, CA (US); Craig Peter Sayers, Menlo Park, CA (US)

(21) Appl. No.: 13/351,660

(22) Filed: Jan. 17, 2012

(51) Int. Cl. G08B 23/00; G08B 21/00

(52) U.S. Cl. 340/501; 340/540; 340/686.1

(57) ABSTRACT

In a method for delivering an item of interest, identification of the item of interest is received and identification of an action context to trigger delivery of the identified item of interest is received. In addition, the item of interest, the action context, and an association of the item of interest to the action context are stored. Moreover, a determination that an indication regarding the action context has been received is made and the item of interest is delivered.

### BACKGROUND

Mobile devices, such as, smart cellular telephones, tablet computers, laptop computers, and personal media players, are gaining ever-increasing use. The mobile devices are often used for many purposes, such as, to make telephone calls, to search the Internet, to track itineraries, to play video games, to access media files, etc. The mobile devices are also often used to store reminders as well as the times at which the reminders are to be delivered to users. These types of reminders work well when there is a definite time when the reminders are to be delivered.

However, there are many instances where users do not know of the time when such reminders will be useful. For instance, if a user creates a reminder to purchase certain items while at the grocery store, but the user does not know when the user will visit the grocery store, the user may be unable to set the appropriate time for the reminder delivery. In these instances, unless the user remembers to access the reminder at the appropriate time, the reminder will be wasted. As such, the conventional reminders discussed above often fail to actually support the direct need of the user, which is to deliver the reminder to the user when that reminder is likely to be useful to the user.

### BRIEF DESCRIPTION OF THE DRAWINGS

Features of the present disclosure are illustrated by way of example and not limited in the following figure(s), in which like numerals indicate like elements, in which:

FIG. 1 depicts a simplified block diagram of an electronic apparatus for context-based item delivery, according to an example of the present disclosure;

FIG. 2 depicts a flow diagram of a method for delivering an item of interest, according to an example of the present disclosure;

FIGS. 3A and 3B, respectively, depict screenshots, according to two examples of the present disclosure; and

FIG. 4 illustrates a computer system, which may be employed to perform various functions of the context-based item delivery module depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are a method and apparatus for delivering an item of interest. In the method and apparatus disclosed herein, an identification of the item of interest is received, along with an identification of an action context that triggers delivery of the identified item of interest. The item of interest, the action context, and an association of the item of interest and the action context are stored for later retrieval. In addition, when a determination that an indication regarding the action context has been received is made, the item of interest associated with the action context is delivered.

Thus, for instance, a user may set up a reminder for the user or for another user or group of users, in which the reminder is to be delivered when the action context is determined to have been received by an electronic apparatus. According to an example, a user is to manually input the action context into the electronic apparatus, which triggers delivery of the item of interest to the use. Thus, for instance, in instances where the user may not remember what the user is to do when a particular action context occurs, the user may enter the action context and may then be presented with a reminder associated with that action context. According another example, the item of interest may be delivered to the user in response to an automatic determination of the user's action context.

As used throughout the present disclosure, the terms “action context” may be defined as grammar that is associated with one or more activities, that when performed, trigger delivery of an item of interest. Thus, for instance, an action context may define a particular action that is associated with a noun or object, such that, the entity's activities may be monitored to determine whether the particular action on the selected noun or object has been performed by the entity.

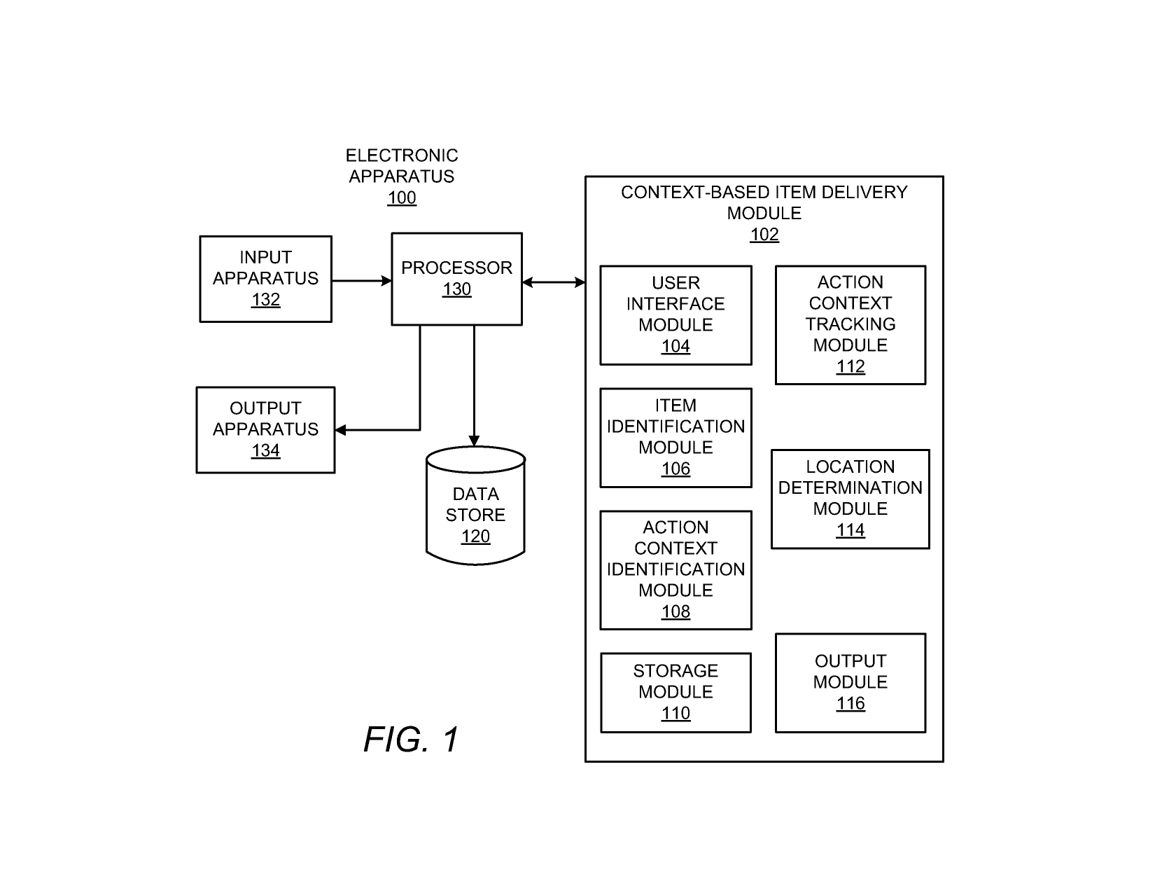

With reference first to FIG. 1, there is shown a simplified block diagram of an electronic apparatus 100 for context-based item delivery, according to an example. It should be understood that the electronic apparatus 100 may include additional elements and that some of the elements depicted therein may be removed and/or modified without departing from a scope of the electronic apparatus 100.

The electronic apparatus 100 may comprise a personal computer, a laptop computer, a tablet computer, a personal digital assistant, a cellular telephone, a portable media player, or other electronic apparatus,. The electronic apparatus 100 is depicted as including a context-based item delivery module 102, which includes a user interface module 104, an item identification module 106, an action context identification module 108, a storage module 110, an action context tracking module 112, a location determination module 114, and an output module 116. The electronic apparatus 100 is also depicted as including a data store 120, a processor 130, an input apparatus 132, an output interface 140, and an output apparatus 142. The processor 130, which may comprise a microprocessor, a micro-controller, an application specific integrated circuit (ASIC), and the like, is to perform various processing functions in the electronic apparatus 100. One of the processing functions includes invoking or implementing the modules 104-116 of the context-based item delivery module 102 as discussed in greater detail herein below.

According to an example, the context-based item delivery module 102 comprises a hardware device, such as, a circuit or multiple circuits arranged on a board. In this example, the modules 104-116 comprise circuit components or individual circuits. According to another example, the context-based item delivery module 102 comprises a volatile or non-volatile memory, such as dynamic random access memory (DRAM), electrically erasable programmable read-only memory (EEPROM), magnetoresistive random access memory (MRAM), Memristor, flash memory, floppy disk, a compact disc read only memory (CD-ROM), a digital video disc read only memory (DVD-ROM), or other optical or magnetic media, and the like. In this example, the modules 104-116 comprise software modules stored in the memory context-based item delivery module 102. According to a further example, the modules 104-116 comprise a combination of hardware and software modules.

According to an example, the context-based item delivery module 102 comprises a set of machine-readable instructions stored on a memory. In this example, the context-based item delivery module 102 comprises an application that may be downloaded or otherwise stored onto the memory and that the processor 130 may execute. In addition, the context-based item delivery module 102 may comprise a set of machine-readable instructions available from the WebOS™ App Catalog or other store from which the machine-readable instructions may be downloaded. In addition, or alternatively, the context-based item delivery apparatus 102 may comprise a standalone application or an application that is to interact with, for instance, a calendar, a reminder, a task list, etc., application.

The input apparatus 132 comprises hardware and/or software to enable the electronic apparatus 100 to receive inputs from a user. The input apparatus 132 may comprise, for instance, a touch sensitive display screen, a keyboard, a track pad, an optical mouse, a microphone, or other input device into an electronic apparatus. The processor 130 may store the received inputs in the data store 120 and may use the data associated with the inputs in implementing the modules 104-116. The data store 120 comprises volatile and/or non-volatile memory, such as DRAM, EEPROM, MRAM, phase change RAM (PCRAM), Memristor, flash memory, and the like. In addition, or alternatively, the data store 120 comprises a device that is to read from and write to a removable media, such as, a floppy disk, a CD-ROM, a DVD-ROM, or other optical or magnetic media.

The output apparatus 134 comprises hardware and/or software to enable data, such as, candidate action contexts, items of interest, etc., to be delivered to a user. The output apparatus 134 may comprise a display screen, a speaker, a printer, etc. In various instances, the output apparatus 134 and the input apparatus 132 comprises a common apparatus, such as, a touch-sensitive display screen.

Although not shown, and according to an example, the electronic apparatus 100 includes hardware and/or software to enable transmission and receipt of data through a network. In this example, the network may comprise a wired and/or a wireless network and the electronic apparatus 100 may include a network interface that enables data communications through either or both of a wired and a wireless connection to the network. Examples of suitable networks include, the Internet, a cellular communications network, etc.

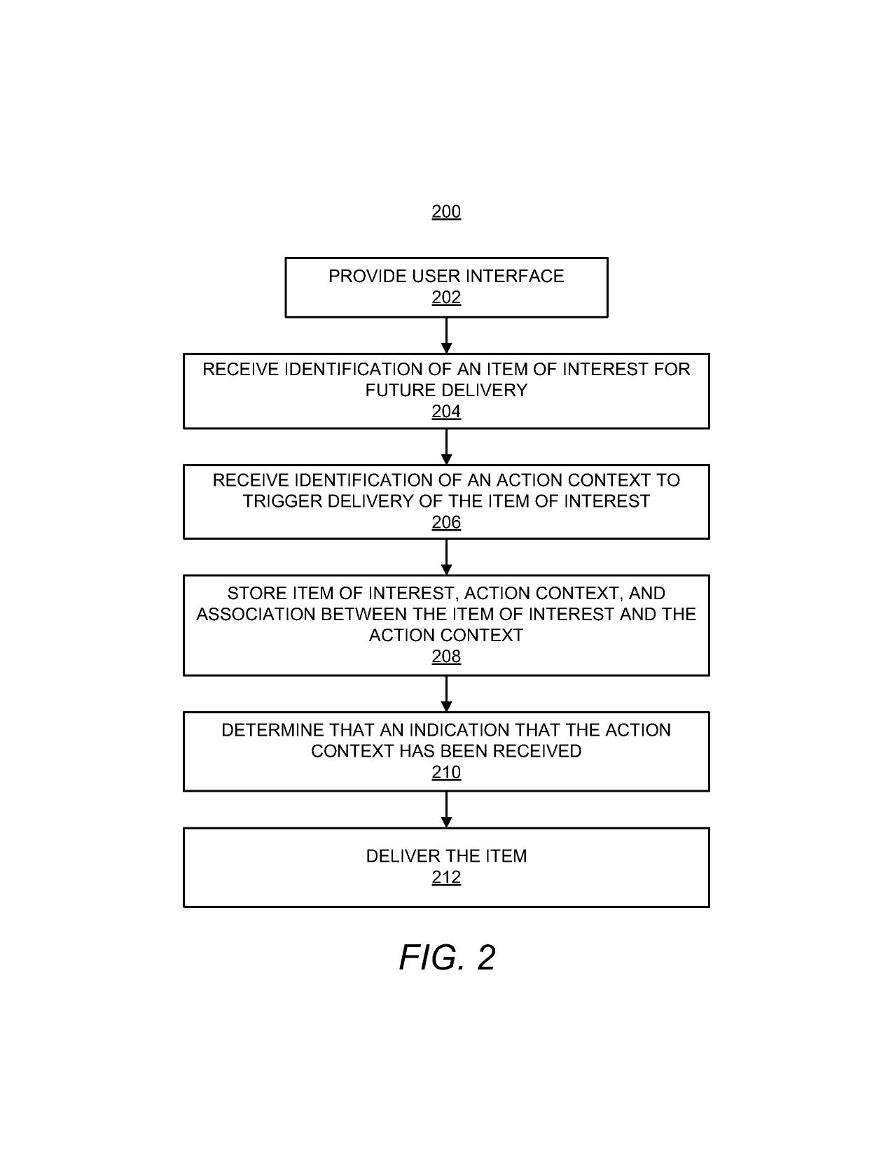

Various manners in which the modules 104-116 of the context-based item delivery module 102 may be implemented are discussed in greater detail with respect to the method 200 depicted in FIG. 2. FIG. 2, more particularly, depicts a flow diagram of a method 200 for delivering an item of interest, according to an example. It should be apparent to those of ordinary skill in the art that the method 200 represents a generalized illustration and that other steps may be added or existing steps may be removed, modified or rearranged without departing from a scope of the method 200. Although particular reference is made to the electronic apparatus 102 depicted in FIG. 1 as comprising an apparatus in which the operations described in the method 200 may be performed, it should be understood that the method 200 may be performed in differently configured apparatuses without departing from a scope of the method 200.

At block 202, a user interface is provided, for instance, by the user interface module 104. According to an example, the user interface is displayed on the output apparatus 134 and provides a plurality of fields into which a user may input various information. As discussed in greater detail below, the user may input and/or select various items of interest and action contexts that are to trigger delivery of the items of interest. The user may input text into the plurality of fields and/or the fields may be prepopulated with items that the user may select. For instance, the user interface may display a list of available contexts that the context-based item delivery module 102 has been programmed to recognize. The available contexts may include, for instance, “at grocery store”, “at automobile dealership”, “I'm hungry”, “I'm bored”, “I'm near the supermarket”, “I'm debugging code”, etc. The available contexts may also include contexts pertaining to other people. In this example, the available contexts may include “when [another person] is near a supermarket”, “when [anyone] is debugging code”, etc. In this regard, the method 200 may be implemented to deliver an item of interest to the user that sets up the item delivery or to deliver the item of interest to another user or group of users.

At block 204, an identification of an item of interest for future delivery is received, for instance, by the item identification module 106. The item comprises an item that is of interest to either the user that inputs the item of interest or to another person. In addition, the user may input the item of interest through the user interface provided at block 202.

At block 206, an identification of an action context to trigger delivery of the item of interest identified at block 204 is received, for instance, by the action context identification module 108. The action context comprises an action context that is applicable to either the user that inputs the action context or another person. The user may input the item of interest through the user interface provided at block 202.

At block 208, the item of interest, the action context, and an association of the item of interest and the action context are stored, for instance, by the storage module 110. More particularly, for instance, the storage module 110 may store the item of interest, the action context, and an association of the item of interest and the action context in the data store 120.

At block 210, a determination that an indication that the action context has been received is made, for instance, by the action context tracking module 112. According to an example, the electronic apparatus 100, and more particularly, the action context tracking module 112 makes the determination from receipt of the action context directly from a user. In this example, the user manually enters a current action context, such as, I am “at a supermarket”, I am “at the gym”, I am “bored”, etc. According to another example, the electronic apparatus 100, and more particularly, the action context tracking module 112 makes the determination based upon information received from the location determination module 114. In this example, the electronic apparatus 100 may be equipped with a global positioning system (GPS) device (not shown) that is able to automatically determine location coordinates of the electronic apparatus 100 and to communicate the location coordinates to the location determination module 114. In addition, the location determination module 114 may determine the location of the electronic apparatus 100 from the location coordinates through, for instance, a comparison of the determined location coordinates and a map of geographical structures associated with the determined location coordinates. In this regard, the location determination module 114 may determine that the electronic apparatus 100, and thus, the user, is in a particular store or other location.

At block 210, the item of interest associated with the action context is delivered by, for instance, the output module 116. More particularly, for instance, the output module 116 causes the item of interest to be delivered through the output apparatus 134. By way of example, the item of interest is displayed on the output apparatus 134. According to another example, in which the output apparatus 134 comprises a speaker, the item of interest is outputted as an audio output.

According to an example, the method 200 is employed by a user to deliver an item of interest to the user at a future time. In another example, the method 200 is employed by a user to deliver an item of interest to another user or to a group of other users at a future time. In this example, the method 200 may include additional operations for communicating the received items of interest and the action contexts to electronic apparatuses of the other user(s). For instance, the output module 116 may communicate the received items of interest and the action contexts to the appropriate user(s) through an Internet connection, through a cellular network connection, a local area network connection, etc.

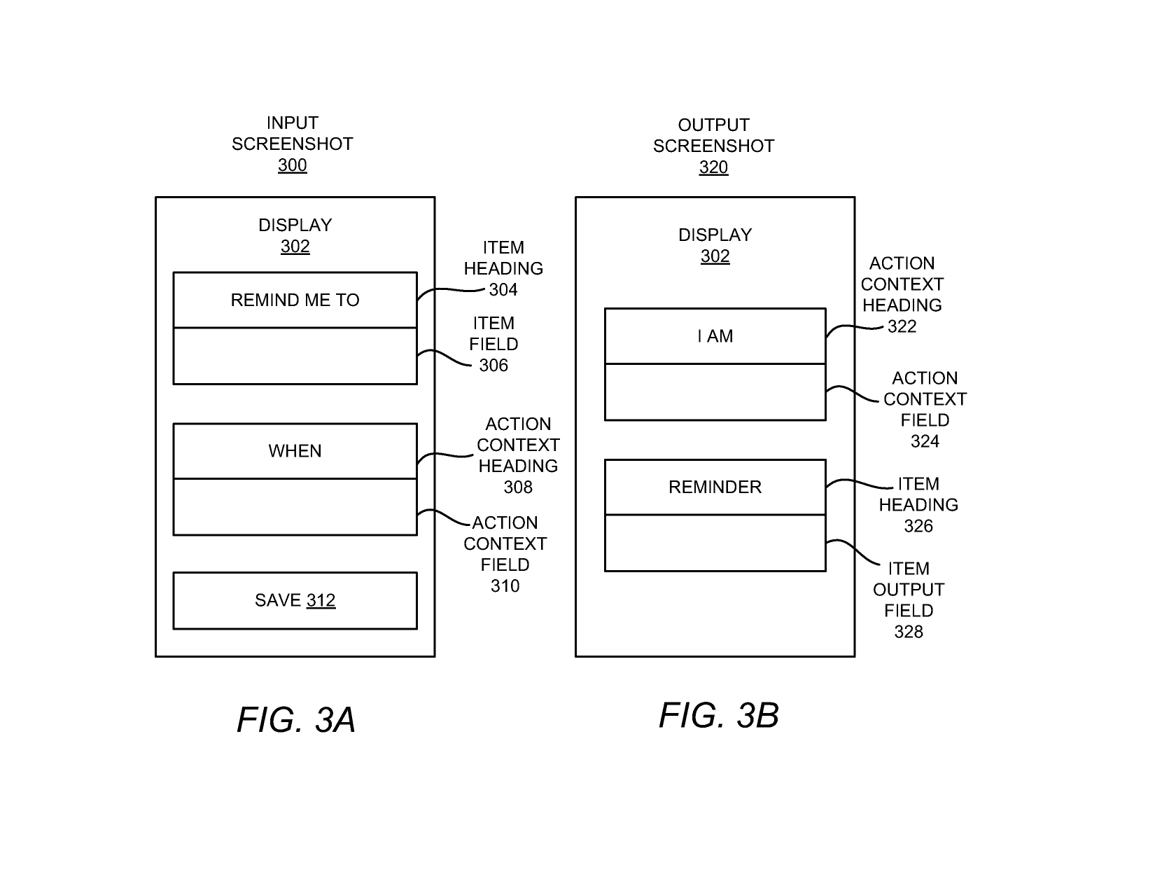

Turning now to FIGS. 3A and 3B, there are shown respective diagrams of an input screenshot 300 and an output screenshot 320, according to two examples. It should clearly be understood that the screenshots 300 and 320 depicted in FIGS. 3A and 3B are merely examples and are thus not to limit any aspect of the method or apparatus disclosed herein.

With reference first FIG. 3A, the display 302 may comprise the input apparatus 132 and/or the output apparatus 134 of the electronic apparatus 100 depicted in FIG. 1. Thus, for instance, the display 302 may comprise a touch-sensitive screen that is able to track any user's interactions with the display 302 as well as to display various information. The display 302 may, however, comprise display that is not touch-sensitive.

As shown in FIG. 3A, a user interface comprising various types of headings and related fields are provided, for instance, by the user interface module 104. More particularly, an item heading 304 and an item field 306 are depicted as being provided in the user interface. The item heading 304 has been depicted as reciting “REMIND ME TO” and a user may enter an item of interest in the item field 306 related to the item heading 304. By way of particular example, the item of interest may comprise an item to purchase while at a grocery store.

As also shown in FIG. 3A, an action context heading 308 and an action context field 310 are provided. The action context heading 308 has been depicted as reciting “WHEN” and a user may enter an action context in the action context field 310 related to the action context heading 308. By way of particular example, the action context comprises any recitation of a particular action context, such as, “I am at the grocery store”. In addition, the action context heading 308 may correspond to the selected item heading 304. That is, for instance, the action context heading 308 may change automatically as the item heading 304 is changed.

According to an example, a plurality of different item headings 304 and/or action context headings 308 are provided for selection by a user. In this example, the various item headings 304 and/or action context headings 308 may be provided as a dropdown listing of candidate item headings 304 and/or action context headings 308. Thus, a user may select the desired item heading 304 from a list of candidate item headings 304 and may enter an item of interest in the item field 306 that is related to the selected item heading 304. Likewise, the user may select the desired action context heading 308 from a list of candidate action context headings 308 and may enter an action context in the action context field 310 that is related to the selected action context heading 308.

The listing of candidate item headings in the item heading 304 and/or the listing of candidate action context headings in the action context heading 308 may be arranged in any suitable manner. For instance, each of the listings may be arranged in alphabetical order, by usage, by popularity, etc. In addition, the arrangements of the listings may be based upon the user's rankings or rankings that are determined based upon other users' rankings. Thus, for instance, the item headings 304 and/or the action context headings 308 that are selected the most often by a number of users may be determined and the listing of the candidate items in the item heading 304 and/or the listing of candidate action context headings in the action context heading 308 may be arranged according to the popularities of the determined item headings and/or action context headings. In addition, or alternatively, the listing of candidate item headings in the item heading 304 and/or the listing of candidate action context headings in the action context heading 308 may be arranged differently depending on the location of the user and/or the current time and day. For example the listing(s) may be ordered based on the popularity of the item considering only past interactions at the user's current location.

In addition or alternatively, the item field 306 and/or the action context field 310 may include a dropdown listing of candidate items and/or action contexts. Thus, a user may select the item of interest from a list of candidate items. Likewise, the user may select the action context from a list of candidate action contexts. The listing of candidate items displayed in the item field 306 and/or the listing of candidate action contexts in the action context field 310 may be arranged in any suitable manner. For instance, each of the listings may be arranged in alphabetical order, by usage, by popularity, etc. In addition, the arrangements of the listings may be based upon the user's rankings or rankings that are determined based upon other users' rankings. Thus, for instance, the items in the item field 306 and/or the action contexts in action context field 310 that are selected the most often by a number of users may be determined and the listing of the candidate items in the item field 306 and/or the listing of candidate action contexts in the action context field 310 may be arranged according to the popularities of the determined items and/or action contexts. In addition, or alternatively, the items in the item field 306 and/or the action contexts in the action context field 310 may be arranged differently depending on the location of the user and/or the current time and day. For example the items and/or actions contexts may be ordered based on the popularity of the item/action context considering only past interactions at the user's current location.

As further shown in FIG. 3A, a save “button” 312 is provided to enable a user to save the entries provided in the item field 306 and the action context field 310. In this regard, a user may select the save button 312 following entry of the item of interest into the item field 306 and the action context into the action context field 310. In addition, the item of interest, the action context, and an association of the item of interest and the action context are stored in the data store 120 upon selection of the save button 312.

Turning now to FIG. 3B, the output screenshot 320 depicts the display 302, which may comprise the output apparatus 134. The output screenshot 320 is depicted as including an action context heading 322 and an action context field 324. The action context heading 322 is depicted as reciting “I AM” and a user may enter a current action context or status in the action context field 324. By way of particular example, the user may enter a recitation that they are near a supermarket in the action context field 324. As other examples, the user may enter a recitation that they are “bored”, “debugging code”, “searching for a flight reservation”, etc.

According to an example, a plurality of different action context headings 322 are provided for selection by a user. In this example, the various action context headings 322 may be provided as a dropdown listing of candidate action context headings 322. Thus, a user may select the desired action context heading 322 from a list of possible action context headings 322 and may enter an action context in the action context field 324 that is related to the selected action context heading 322. In addition, the action context field 324 may include a listing of candidate action contexts associated with different action context headings 322. Thus, for instance, selection of different action context headings 322 may result in different listings of candidate action contexts in the action context field 324.

The listing of candidate action context headings in the action context heading 322 and/or the listing of candidate action contexts in the action context field 324 may be arranged in any suitable manner. For instance, each of the listings may be arranged in alphabetical order, by usage, by popularity, etc. In addition, the arrangements of the listings may be based upon the user's rankings or rankings that are determined based upon other users' rankings. Thus, for instance, the action context headings 322 that are selected the most often by a number of users may be determined and the listing of the candidate action context headings in the action context heading 322 may be arranged according to the popularities of the determined item headings and/or action context headings. In addition, or alternatively, the action context headings and/or the listing of candidate action contexts may be arranged differently depending on the location of the user and/or the current time and day. For example, the action context headings and/or the listing of candidate action contexts may be ordered based on the popularity of the action context heading and/or the candidate action context considering only past interactions at the user's current location at a similar time of day.

In addition or alternatively, the listing of the candidate action contexts in the action context field 324 may be arranged in any suitable manner. For instance, the listing may be arranged in alphabetical order, by usage, by popularity, etc. In addition, the listing may be arranged based upon the user's rankings or rankings that are determined based upon other users' rankings. Thus, for instance, the action contexts in action context field 324 that are selected the most often by a number of users may be determined and the listing of the candidate action contexts in the action context field 324 may be arranged according to the popularities of the determined action contexts. In this regard, the listing of candidate action contexts may be arranged to enable a user to relatively quickly find and select the desired action context. In addition or alternatively, the listing of candidate action contexts may be arranged differently depending on the location of the user and/or the current time and day. For example, candidate action contexts may be ordered based on the popularity of the item considering only past interactions at the user's current location at a similar time of day.

According to an example, the arrangements of the listings of the candidate action context headings 322 and/or the candidate action contexts are based upon the time at which a user is accessing the context-based item delivery module 102. Thus, for instance, the listings may be arranged to show a particular order of candidate action contexts at a particular time and to show a different order of candidate action contexts at a different time. As a further example, the arrangements of the listings are based upon a detected location of the electronic apparatus 100. In this example, the location determination module 114 may automatically detect a location of the electronic apparatus 100 as discussed above and the action context identification module 108 may arrange the listings according to the detected location, as discussed above.

As also shown in FIG. 3B, an item heading 326 and an item output field 328 are provided. The item heading 326 has been depicted as reciting “REMINDER”. In addition, the item output field 328 is to display the item of interest associated with the action context inputted into the action context field 324. Thus, for instance, the data store 120 may be accessed to determine the item of interest associated with the action context entered into the action context field 324.

The various selections made by a number of users may be tracked by a server (not shown) to which the context-based item delivery module 102 of multiple users may communicate various information. Thus, for instance, the context-based item delivery module 102 may be programmed to communicate the various selections to the server and the server may determine the rankings of the various selections. The server may also communicate the rankings of the various selections back to the context-based item delivery module 102 and the context-based item delivery module 102 may use the rankings to arrange the order in which the listings of various information are provided.

According to an example, the action context identification module 108 may determine the action contexts that are available for selection through the user interface through an analysis of collaborative data pertaining to action contexts specified by a plurality of entities. The entities may include the user and other users. In this regard, the electronic apparatus 100 may be in communication with a number of computing devices over a network, such as, the Internet, and may gather data from the number of computing devices. Thus, for instance, the action context identification module 108 or a different device, such as, a server connected to the network (not shown), may determine which of the action contexts specified by the entities are the most common or most popular and may present those action contexts to the user through the user interface. Popularity may here mean, among other things, simply the most popular action contexts chosen by entities (users) (for instance, if the population of users happens to be people who travel often, then, other things being equal, the most likely appropriate action contexts may be travel-related), or the most popular action context determined for specific items (for instance, certain items, regardless of the nature of the general user population might always be associated with certain action contexts, such as a real estate pricing website and the action context “researching a new home”), or some combination thereof. As such, the action contexts may be developed through an analysis of collective actions of multiple entities.

According to another example, anonymous data from the items of interest and action contexts of many users may be analyzed and aggregated to determine popular action contexts, and popular items of interest. These may then be displayed through alternative interfaces. For example, a website may show the most popular items of interest people want to remember when they “are bored”, or the most popular locations when the reminder mentions synonyms of “purchase”, etc.

It should be understood that a user may select a particular option or input data through any reasonably suitable manner. Thus, for instance, a user may input instructions through manual selection of particular options or text. In addition, or alternatively, a user may input instructions through input of voice commands. Thus, for instance, a user may verbally input an item of interest into the item field 306 and/or an action context into the action context field 310. Moreover, the item of interest outputted in the item output field 328 may be displayed on a display and/or may be outputted as audio through a speaker.

Some or all of the operations set forth in the method 200 may be contained as a utility, program, or subprogram, in any desired computer accessible medium. In addition, the method 200 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

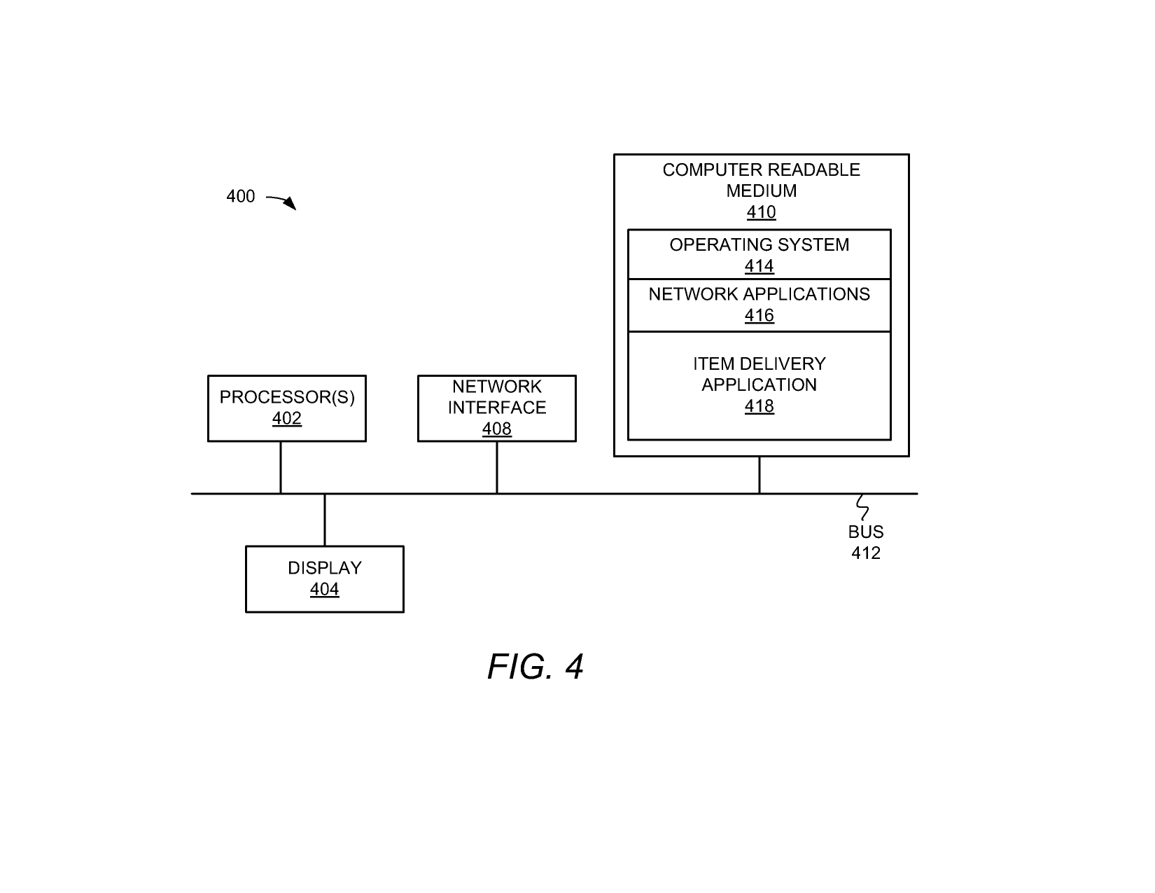

Turning now to FIG. 4, there is shown a schematic representation of a computing device 400, which may be employed to perform various functions of the context-based item delivery module 102 depicted in FIG. 1, according to an example. The device 400 includes a processor 402, a display 404, such as a monitor; a network interface 408, such as a Local Area Network LAN, a wireless 802.11x LAN, a 3G mobile WAN or a WiMax WAN; and a computer-readable medium 410. Each of these components is operatively coupled to a bus 412. For example, the bus 412 may be an EISA, a PCI, a USB, a FireWire, a NuBus, or a PDS.

The computer readable medium 410 may be any suitable medium that participates in providing instructions to the processor 402 for execution. For example, the computer readable medium 410 may be non-volatile media, such as an optical or a magnetic disk; volatile media, such as memory. The computer-readable medium 410 may also store an operating system 414, such as Mac OS, MS Windows, Unix, or Linux; network applications 416; and an item delivery application 418. The operating system 414 may be multi-user, multiprocessing, multitasking, multithreading, real-time and the like. The operating system 414 may also perform basic tasks such as recognizing input from input devices, such as a keyboard or a keypad; sending output to the display 404; keeping track of files and directories on the computer readable medium 410; controlling peripheral devices, such as disk drives, printers, image capture device; and managing traffic on the bus 412. The network applications 416 include various components for establishing and maintaining network connections, such as machine-readable instructions for implementing communication protocols including TCP/IP, HTTP, Ethernet, USB, and FireWire.

The item delivery application 418 provides various components for managing delivery of an item of interest as described above with respect to the method 200 in FIG. 2. The item delivery application 418 may thus comprise the context-based item delivery module 102. In this regard, the item delivery application 418 may include modules for receiving identification of the item of interest, receiving identification of an action context to trigger delivery of the identified item of interest, storing the item of interest, the action context, and an association of the item of interest to the action context, determining that an indication regarding the action context has been received, and delivering the item of interest in response to a determination that the indication regarding the action context has been received. In certain examples, some or all of the processes performed by the management application 418 may be integrated into the operating system 414. In certain examples, the processes may be at least partially implemented in digital electronic circuitry, or in computer hardware, machine-readable instructions (including firmware and/or software), or in any combination thereof.

Although described specifically throughout the entirety of the instant disclosure, representative embodiments of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for delivering an item of interest, said method comprising:
receiving identification of the item of interest;
receiving identification of an action context to trigger delivery of the identified item of interest;
storing the item of interest, the action context, and an association of the item of interest to the action context;
determining, by a processor, that an indication regarding the action context has been received; and
delivering the item of interest.

2. The method according to claim 1, further comprising:
receiving an input from a user regarding the action context; and
wherein determining whether an indication regarding the action context has been received further comprises determining that an indication regarding the action context has been received when the input from the user regarding the action context is received.

3. The method according to claim 1, further comprising:
displaying a plurality of candidate items; and
wherein receiving an item of interest further comprises receiving selection of the item of interest from the plurality of candidate items.

4. The method according to claim 1, further comprising:
displaying a plurality of candidate action contexts;
wherein receiving an action context to trigger delivery of the item further comprises receiving selection of the action context from the plurality of action contexts.

5. The method according to claim 4, further comprising:
determining an order in which the plurality of candidate action contexts are to be displayed; and
wherein displaying the plurality of candidate action contexts further comprises displaying the plurality of action contexts according to the determined order.

6. The method according to claim 5, wherein the displaying the plurality of candidate action contexts further comprises displaying the plurality of candidate action contexts on an electronic apparatus, said method further comprising:
determining a location of the electronic apparatus; and
wherein determining an order in which the plurality of candidate action contexts are to be displayed further comprises determining the order based upon the determined location of the electronic apparatus.

7. The method according to claim 6, wherein determining the location of the electronic apparatus further comprises determining the location of the electronic apparatus automatically.

8. The method according to claim 5, wherein determining an order in which the plurality of candidate action contexts are to be displayed further comprises determining the order in which the plurality of candidate action contexts are to be displayed based upon an analysis of other users' action context selections.

9. The method according to claim 1, further comprising:
providing an interface comprising fields for receipt of the identification of the item of interest and the identification of the action context, wherein the respective fields are pre-populated with listings of candidate items of interest and candidate action contexts.

10. The method according to claim 9, further comprising:
determining different orderings of the candidate action contexts based upon the selected candidate item of interest.

11. An electronic apparatus for delivering an item of interest, said electronic apparatus comprising:
a module to receive identification of the item of interest, to receive identification of an action context to trigger delivery of the identified item of interest, to store the item of interest, the action context, and an association of the item of interest to the action context, to receive an indication regarding the action context from a user, and to deliver the item of interest; and
a processor to implement the module.

12. The electronic apparatus according to claim 11, wherein the module is further to determine an order in which the plurality of candidate action contexts are to be displayed and to display the plurality of candidate action contexts according to the determined order.

13. The electronic apparatus according to claim 12, wherein the module is further to determine a location of the electronic apparatus and to determine the order in which the plurality of candidate action contexts are to be displayed based upon the determined location of the electronic apparatus.

14. The electronic apparatus according to claim 11, wherein the module is further to provide an interface comprising fields for receipt of the identification of the item of interest and the identification of the action context, wherein the respective fields are pre-populated with listings of candidate items of interest and candidate action contexts.

15. A non-transitory computer readable storage medium on which is embedded machine readable instructions, said machine readable instructions, when executed, implementing a method for delivering an item of interest, said at least one computer program comprising computer readable code to:
receive identification of the item of interest;
receive identification of an action context to trigger delivery of the identified item of interest;
store the item of interest, the action context, and an association of the item of interest to the action context;
receive an indication regarding the action context from a user; and
delivering the item of interest.
